(19) United States
(12) Patent Application Publication
(10) Pub. No.: US 2023/0036956 A1
(43) Pub. Date: Feb. 2, 2023

(54) FRACTURING PUMP ASSEMBLY

(71) Applicant: Moien Ibrahim Louzon, Phoenix, AZ (US)

(72) Inventor: Moien Ibrahim Louzon, Phoenix, AZ (US)

(21) Appl. No.: 17/391,587

(22) Filed: Aug. 2, 2021

(51) Int. Cl. F04B 1/00; F04B 9/02; F04B 53/00; F16C 5/00

(52) U.S. Cl. CPC F04B 1/005; F04B 9/02; F04B 53/006; F16C 5/00

(57) ABSTRACT

An improved fracturing pump is provided. The pump is reconfigurable on site. Internal components of the pump may be varied to meet the requirements of a specific operation. The reconfiguration gives the user the ability to increase or decrease the horsepower of the pump. A closed loop oil feed system provides constant and reliable lubrication even under heavy loads. The sealing system is enhanced to reduce leaks and thermal stresses. The pump also has an improved frame and chassis to reduce NVH and enhance reliability.

### BACKGROUND OF THE INVENTION

### 1. Field of the Invention

This invention relates to pumps, and in particular, to an improved fracturing pump assembly.

### 2. Description of the Prior Art

Drilling and production systems are often employed to access and extract hydrocarbons from subterranean formations. These systems may be located onshore or offshore depending on the location of a desired resource. Further, such systems generally include a wellhead assembly mounted on a well through which the resource is accessed or extracted. These wellhead assemblies may include a wide variety of components, such as various casings, valves, pumps, fluid conduits, and the like, that control drilling or extraction operations.

Drilling and production operations, such as fracking, employ fluids referred to as drilling fluids to provide lubrication and cooling of the drill bit, clear away cuttings, and maintain desired hydrostatic pressure during operations. Drilling fluids can include all types of water-based, oil-based, or synthetic-based drilling fluids. Pumps can be used to move large quantities of fluid. Operations come to a halt if the pumps fail, and thus, reliability under harsh conditions, using all types of abrasive fluids, is of utmost commercial interest. Also, portability of these pumps is an issue, so having a versatile pump which can meet the needs of virtually any situation would be desirable.

An improved fracturing pump is provided. The pump is reconfigurable on site. Internal components of the pump may be varied to meet the requirements of a specific operation. The reconfiguration gives the user the ability to increase or decrease the horsepower of the pump. A closed loop oil feed system provides constant and reliable lubrication even under heavy loads. The sealing system is enhanced to reduce leaks and thermal stresses. The pump also has an improved frame and chassis to reduce NVH and enhance reliability.

### SUMMARY OF THE INVENTION

It is a major object of the invention to provide an improved fracturing pump assembly.

It is another object of the invention to provide a fracturing pump assembly with interchangeable parts.

It is another object of the invention to provide a fracturing pump assembly with a variable power output.

It is another object of the invention to provide a fracturing pump assembly having an improved frame which utilizes partition support.

It is another object of the invention to provide a fracturing pump assembly where the pump frame is integrated into the skid chassis.

It is another object of the invention to provide a fracturing pump assembly with a closed loop lubricating system.

### BRIEF DESCRIPTION OF THE DRAWINGS

FIG. 1 generally depicts a wellsite system, in accordance with one or more implementations described herein.

FIG. 2 shows a side cutaway view of a prior art pump.

FIG. 3 shows a perspective view of a first embodiment of the fracturing pump assembly of the invention.

FIG. 4 shows a perspective view, partly in section, of pump assembly of FIG. 3.

FIG. 5 shows a side cutaway view of an alternative embodiment of the fracturing pump assembly.

FIG. 6 shows a perspective view of an alternative embodiment of the fracturing pump assembly of the invention.

FIG. 7 shows a perspective view of the chassis of the fracturing pump of FIG. 6.

FIG. 8 shows a side view of the pump of FIG. 6 driven by a turbine.

FIG. 9 shows a side view of the pump of FIG. 6 driven by an electric motor.

### DETAILED DESCRIPTION OF THE PREFERRED EMBODIMENTS

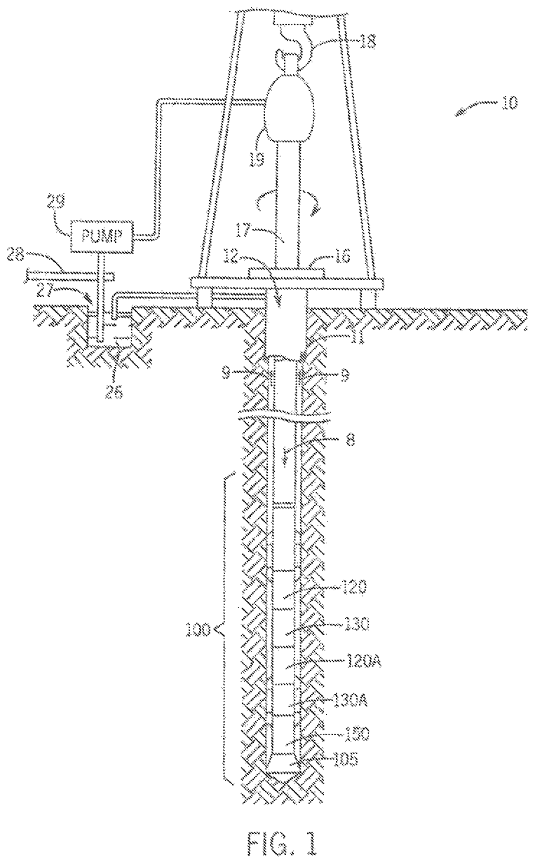

Generally speaking, FIG. 1 illustrates a wellsite system in which the inventive fracturing pump can be employed. The wellsite system of FIG. 1 may be onshore or offshore. In the wellsite system of FIG. 1, a borehole 11 may be formed in subsurface formations by rotary drilling using any suitable technique. A drill string 12 may be suspended within the borehole 11 and may have a bottom hole assembly 100 that includes a drill bit 105 at its lower end. A surface system of the wellsite system of FIG. 1 may include a platform and derrick assembly 10 positioned over the borehole 11, the platform and derrick assembly 10 including a rotary table 16, kelly 17, hook 18 and rotary swivel 19. The drill string 12 may be rotated by the rotary table 16, energized by any suitable means, which engages the kelly 17 at the upper end of the drill string 12. The drill string 12 may be suspended from the hook 18, attached to a traveling block (not shown), through the kelly 17 and the rotary swivel 19, which permits rotation of the drill string 12 relative to the hook 18. A top drive system could alternatively be used, which may be a top drive system well known to those of ordinary skill in the art.

In the wellsite system of FIG. 1, the surface system may also include drilling fluid 26 (also referred to as fracturing) stored in a pit/tank 27 at the wellsite. A pump 29 supported on a skid 28 may deliver the drilling fluid 26 to the interior of the drill string 12 via a port in the swivel 19, causing the drilling fluid to flow downwardly through the drill string 12 as indicated by the directional arrow 8. The drilling fluid 26 may exit the drill string 12 via ports in a drill bit 105, and circulate upwardly through the annulus region between the outside of the drill string 12 and the wall of the borehole 11, as indicated by the directional arrows 9. In this manner, the drilling fluid 26 lubricates the drill bit 105 and carries formation cuttings up to the surface, as the drilling fluid 26 is returned to the pit/tank 27 for recirculation. The drilling fluid 26 also serves to maintain hydrostatic pressure and prevent well collapse. The drilling fluid 26 may also be used for telemetry purposes. A bottom hole assembly 100 of the wellsite system of FIG. 1 may include logging-while-drilling (LWD) modules 120 and 120A and/or measuring-while-drilling (MWD) modules 130 and 130A, a roto-steerable system and motor 150, and the drill bit 105.

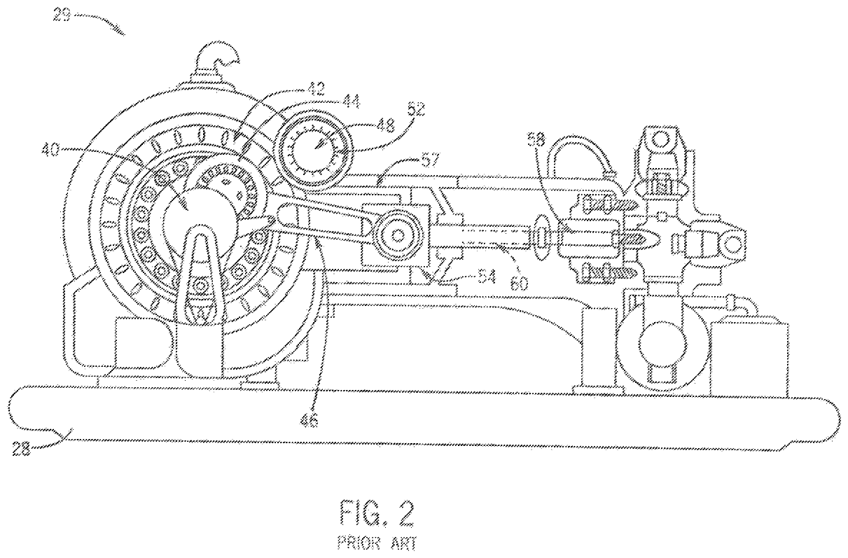

FIG. 2 shows a cutaway side view of a prior art fracturing pump, illustrating various components of the power assembly, the portion of the pump that converts rotational energy into reciprocating motion. A pump as shown in FIG. 2 could be used as pump 29 of FIG. 1, although many other fracturing pumps, including those with designs described below in accordance with certain embodiments of the present technique, could instead be used as pump 29. Pinion gears 52 along a pinion shaft 48 drive a larger gear referred to as a bull gear 42 (e.g., a helical gear or a herringbone gear), which rotates on a crankshaft 40. Pinion shaft 48 is turned by a motor (not shown). The crankshaft 40 turns to cause rotational motion of hubs 44 disposed on the crankshaft 40, each hub 44 being connected to or integrated with a connecting rod 46. By way of the connecting rods 46, the rotational motion of the crankshaft 40 (and hub 44 connected thereto) is converted into reciprocating motion. The connecting rods 46 couple to a crosshead 54 (a crosshead block and crosshead extension as shown may be referred to collectively as the crosshead 54 herein). The crosshead 54 moves translationally constrained by guide 57. Pony rods 60 connect the crosshead 54 to a piston 58. In the fluid end of the pump, each piston 58 reciprocates to move fracturing in and out of valves in the fluid end of the pump 29.

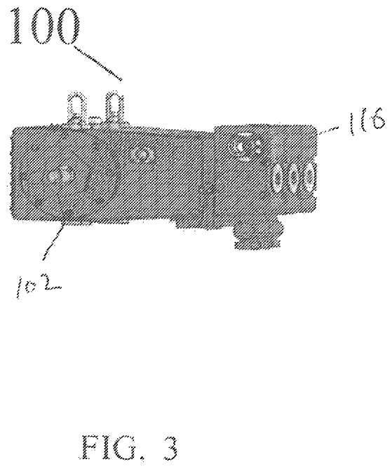

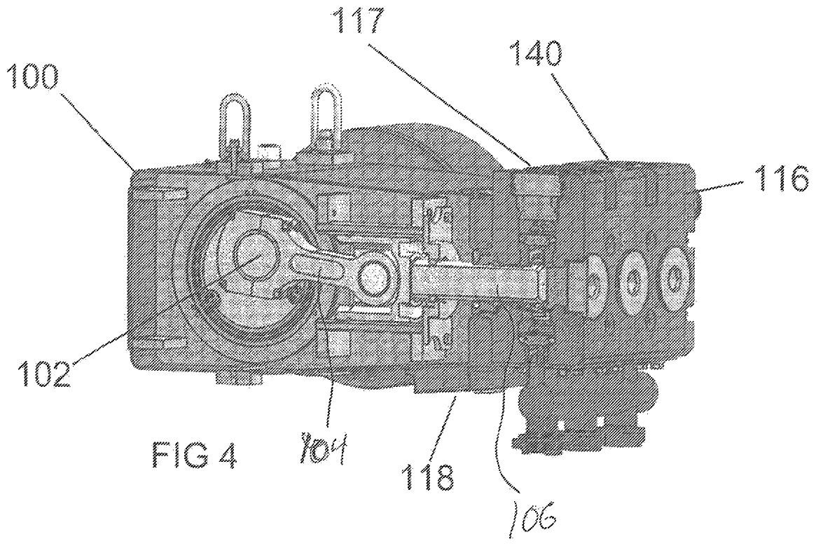

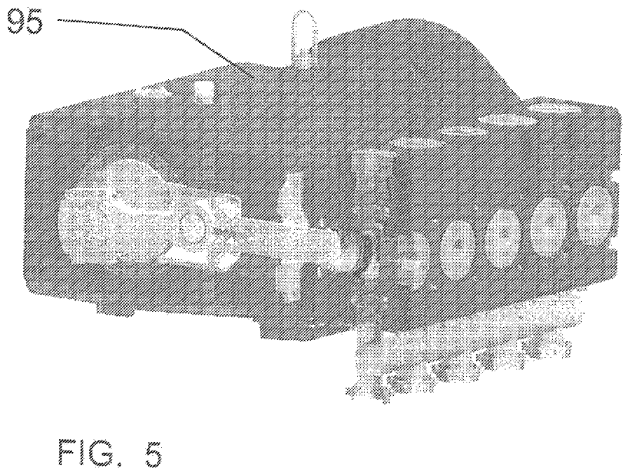

Referring now to FIGS. 3-4 a first embodiment of the pump 100 is shown. This pump 100 is a triplex pump. The second embodiment is shown in FIG. 5. The embodiment 95 shown in FIG. 5 is a quintuplex pump. But the advantages, form, and function are shared with the triplex pump 100 of FIG. 3.

It can be seen that the pump 100 has a crankshaft 102, which drives connecting rods 104, which ultimately cause reciprocating action of the pistons 106 to create pumping action as in the prior art model. The pump 100 has an enhanced structural arrangement to increase pump reliability. By increasing the size of key components such as the crossheads 116, and crankshaft 102 the pump 100 can handle greater loads. A closed loop oil feed system 118 is part of an optimized lubrication system which reduces friction between crosshead 116 and crosshead guides 117. Low operating lube oil temperatures and high mechanical efficiency increase reliability.

A robust sealing system is provided to improve leak and thermal stresses handling during harsh high temperature fracturing operation in the field. As previously stated, the interior components of the pump, including the plunger 140, can be interchangeably replaced to increase power output, a key aspect of the invention. In a preferred embodiment power generation ranges from 600 HP to 750 for the triplex pump 100, and to about 1000 HP for the quintuplex pump 95. Also, the pumps 95, 100 allow high pressure output and high flow rate based on variance of plunger size.

Crosshead 116 is designed to improve friction issues and reduce wear and noise, which increases stroke component life and improves lubrication. The design also reduces contamination by utilizing fluid mechanics and thermodynamics.

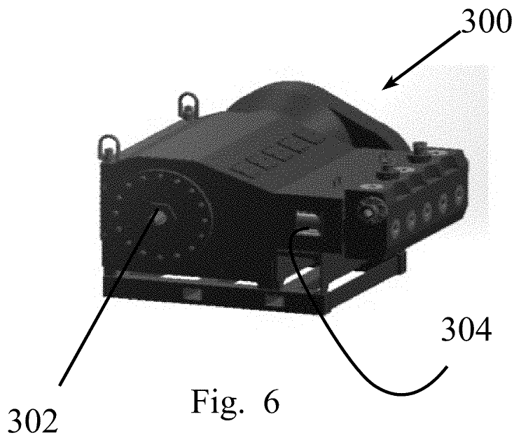

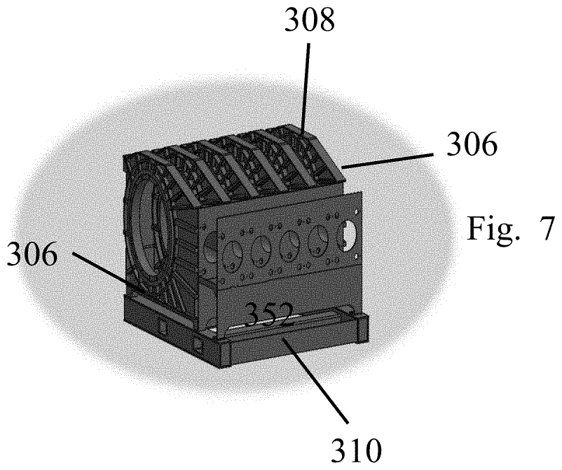

Referring now to FIGS. 6-9, another alternative embodiment of the pump is shown. This embodiment, indicated generally by the numeral 300 is a quintuplex pump. This variation of pump 300 includes a crankshaft 302 and function to operate plungers 304 which effect pumping action. The size of plungers 304 can be varied to allow for variable pumping output as in the prior embodiment 100, 200. Power end frame plates 306 are designed and built from high strength grade steel alloy yet optimized for light weight. In a key aspect of the invention, the pump frame 308 and skid 310 are integrated to provide rigidity and reduce deflection of stroke components and increase life cycle and durability.

The pump 300 may be powered by a conventional diesel engine as is known in the art. The diesel engine (not shown) can provide between 3000 and 5000 horsepower to drive the pump. Alternatively, the pump 300 may be powered by an electric motor or a gas turbine.

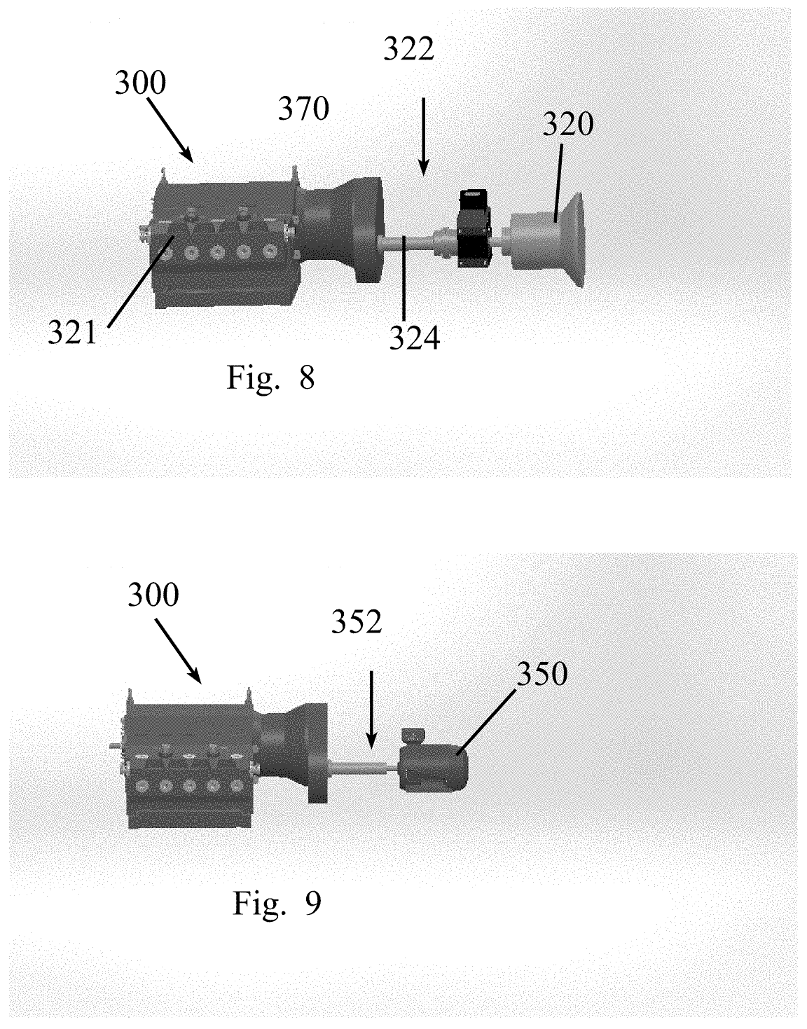

Referring now to FIG. 8, the pump 300 is shown connected to a gas turbine 320. The turbine 320 is a conventional gas turbine which can output between 3000 and 5000 HP as noted above. The fluid handling end 321 of the pump 300 includes robust seals to prevent leakage, the end 321 removable to facilitate service. A crankshaft arrangement 322 couples the turbine 320 to the pump 300. The arrangement 322 includes a segmented drive shaft 324 having a controller for regulating rotating output from the turbine. FIG. 9 shows the pump 300 driven by an electric motor 350. The motor 350 is a conventional electric motor outputting between 3000 and 5000 HP. A crankshaft arrangement 352 couples the motor 350 to the pump 300. A torque converter 370 (IS THIS TRUE?) can receive power from either the turbine 320 or the electric motor 350.

It is to be understood that the present invention is not limited to the sole embodiment described above, but encompasses any and all embodiments within the scope of the following claims:

I claim:

1. A fracturing pump assembly comprising: a frame having a plurality of bores formed therethrough; and a plurality of crossheads disposed in the plurality of bores, respectively, and adapted to reciprocate therein;
a crankshaft for imparting motive power to a plunger, said plunger situated in the fluid handling end of the pump, whereby rotation of said crankshaft causes reciprocating movement of said plunger which causes fluid to be expelled from the fluid handling end of the pump.

2. The assembly of claim 1 wherein said crosshead may be varied in size to increase power output.

3. The assembly of claim 1 wherein said plunger may be varied in size to increase power output.
